(19) United States
(12) Patent Application Publication
(10) Pub. No.: US 2008/0140979 A1
(43) Pub. Date: Jun. 12, 2008

(54) METHOD OF ALLOCATING STACK IN MULTI-THREADED SENSOR OPERATING SYSTEM ENVIRONMENT

(76) Inventors: Sang Cheol KIM, Daejeon (KR); Chang Min SHIN, Daejeon (KR); Jin Ho CHANG, Daejeon (KR); Hae Yong KIM, Daejeon (KR); Yoo Kun CHO, Seoul (KR); Ji Man HONG, Seoul (KR); Jun Young HEO, Seoul (KR); Sang Ho YI, Seoul (KR); Bon Cheol GU, Seoul (KR); Hong MIN, Gwangju (KR); Seung Woo LEE, Seoul (KR)

Correspondence Address: LADAS & PARRY LLP, 224 SOUTH MICHIGAN AVENUE, SUITE 1600, CHICAGO, IL, 60604, US

(21) Appl. No.: 11/753,023

(22) Filed: May 24, 2007

(30) Foreign Application Priority Data
Dec. 12, 2006 (KR) 10-2006-126390
Mar. 27, 2007 (KR) 10-2007-29595

(51) Int. Cl. G06F 12/00

(52) U.S. Cl. 711/170

(57) ABSTRACT

Provided is a method of allocating a stack in a multi-threaded sensor operating system environment. The method dynamically allocates as much stack space as is required by a thread, thereby enabling efficient use of stack space. The method includes the steps of: whenever a function is called while a thread is performing an operation, dynamically allocating a stack space to be used by the called function; and when execution of the function is finished, returning the allocated stack space.

### CROSS-REFERENCE TO RELATED APPLICATION

This application claims priority to and the benefit of Korean Patent Application Nos. 2006-0126390, filed Dec. 12, 2006 and 2007-0029595, filed Mar. 27, 2007, the disclosures of which are incorporated herein by reference in their entirety.

### BACKGROUND

1. Field of the Invention

The present invention relates to a method of allocating a stack in a multi-threaded sensor operating system environment, and more particularly, to a stack allocation method dynamically allocating as much stack space as is required by a thread, and thereby enabling efficient use of stack space in a multi-threaded sensor operating system environment.

2. Discussion of Related Art

In general, wireless sensor networks sense various pieces of environmental information, process it in forms desired by users, and perform real-time communication. Such a wireless sensor network comprises several hundreds or thousands of wireless sensor nodes, each of which must be formed to have a very small size for the cost efficiency of an entire network. The sensor nodes function to collect environmental information, communicate with neighboring nodes, and process and send the information to users in real time.

Each of the sensor nodes comprises: a sensor obtaining information on temperature, humidity, light intensity, and so on; a central processing unit (CPU) capable of performing simple calculation; a radio frequency (RF) module for wireless communication; a small-size read only memory (ROM) for booting; a main battery; and so on. For example, a MICA-series sensor platform designed at the University of California, Berkeley in the United States, comprises an 8-bit CPU, a 4 KB random access memory (RAM), two AA batteries, and so on.

A sensor operating system operating in such a sensor platform needs a multi-threaded task management technique for processing several operations, such as sensing, communication, transition, etc., that may be performed at a sensor node, while efficiently using limited memory space.

To this end, upon generation of a thread, a conventional static thread stack allocation method allocates stack space of a static size to be used by the corresponding thread. In other words, each thread must be allocated a unique stack in memory space.

Such stack space allocation causes a significant problem in a sensor platform having very limited memory space. When a thread does not use an entire allocated stack space, remaining stack space is wasted. Therefore, static allocation and restoration of stack memory space in a space-limited wireless sensor platform may cause a serious problem in resource management.

Such a problem actually results in memory shortage of a system and causes a malfunction of an entire wireless sensor network. Thus far, there has been no method of solving the problem in the multi-threaded task management technique.

Meanwhile, there was an attempt to solve the problem in memory space using an event-driven programming method rather than a general multi-threaded programming method. However, such an event-driven structure does not provide a preoccupation function for real-time processing.

### SUMMARY OF THE INVENTION

The present invention is directed to a space-efficient thread stack allocation method for a sensor operating system operating on a space-limited sensor platform.

The present invention is also directed to a stack allocation method capable of considerably reducing the amount of used memory space in a multi-threaded sensor operating system environment, in comparison with a conventional static thread stack allocation method.

The present invention is also directed to a space-efficient thread stack allocation method capable of performing multi-tasks in real time while efficiently using an entire memory space.

One aspect of the present invention provides a method of dynamically allocating a stack in a multi-threaded sensor operating system environment, the method comprising the steps of: whenever a function is called while a thread is performing an operation, dynamically allocating a stack space to be used by the called function; and when execution of the function is finished, returning the allocated stack space.

The method may further comprise the step of estimating the size of stack space to be allocated, on the basis of the size of a local variable to be used by the function and the number of function arguments.

The method may further comprise the step of estimating the size of stack space to be allocated, by analyzing assembly codes corresponding to the function.

Another aspect of the present invention provides a method of dynamically allocating a stack in a multi-threaded sensor operating system environment, the method comprising the steps of: when a function is called while a thread is performing an operation, allocating stack space to be used by the called function; moving a stack pointer to point at the allocated stack space; storing arguments and a return address of the function in the stack space; when execution of the function is finished, returning the function; and restoring the stack pointer, and returning the allocated stack space.

### BRIEF DESCRIPTION OF THE DRAWINGS

The above and other objects, features and advantages of the present invention will become more apparent to those of ordinary skill in the art by describing in detail preferred embodiments thereof with reference to the attached drawings, in which:

FIG. 1 is a flowchart schematically showing a method of allocating a stack in a multi-threaded sensor operating system environment according to an exemplary embodiment of the present invention;

FIG. 2 is a flowchart showing the stack allocation method of FIG. 1 in further detail;

FIG. 3 illustrates examples of allocated stack space to compare a method of allocating a stack in a multi-threaded sensor operating system environment according to an exemplary embodiment of the present invention with a method of statically allocating a stack according to conventional art; and

FIG. 4 is a graph showing amounts of allocated stack space to compare a method of allocating a stack in a multi-threaded sensor operating system environment according to an exemplary embodiment of the present invention with a method of statically allocating a stack according to conventional art.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

First, terminologies used in the present invention will be described in brief.

The term “thread” refers to an execution unit in one program. For example, according to Java language, each task is expressed as a thread, and several threads can be used at a time, thereby enabling multi-tasking.

The term “function” refers to one unit, such as a standardized subroutine independently performing a specific operation and deriving a result in a program. When a required argument is transferred to a function, the function returns a result value corresponding to the argument.

FIG. 1 is a flowchart schematically showing a method of allocating a stack in a multi-threaded sensor operating system environment according to an exemplary embodiment of the present invention.

As illustrated in FIG. 1, whenever a function is called while a thread is performing an operation, stack space to be used by the function is allocated (step 110).

In an exemplary embodiment of the present invention, the size of stack space to be allocated may be estimated on the basis of the size of a local variable to be used by the corresponding function and the number of function arguments. In addition, by analyzing assembly codes provided by a compiler when a program is compiled, it is possible to more accurately estimate the size of stack space to be used by the function. Using program codes at the level of C language only, it is impossible to know the amount of increase and decrease in stack size of each function at a machine level code actually operating in an embedded system or a sensor node. Therefore, by analyzing assembly codes corresponding to a function, the size of stack space can be estimated more accurately. Assembly codes are obtained by translating a machine code into an assembly language. By analyzing the assembly codes, it is possible to accurately know the amount of stack space used by each function.

The result obtained by measuring stack space used by each function may be recorded in an additional file, and new stack space may be allocated on the basis of the recorded information at every point in time that a function is called.

Therefore, according to the inventive method of allocating a stack, stack overflows can be prevented.

When execution of the function using the allocated stack space is finished, the used stack space is returned (step 120).

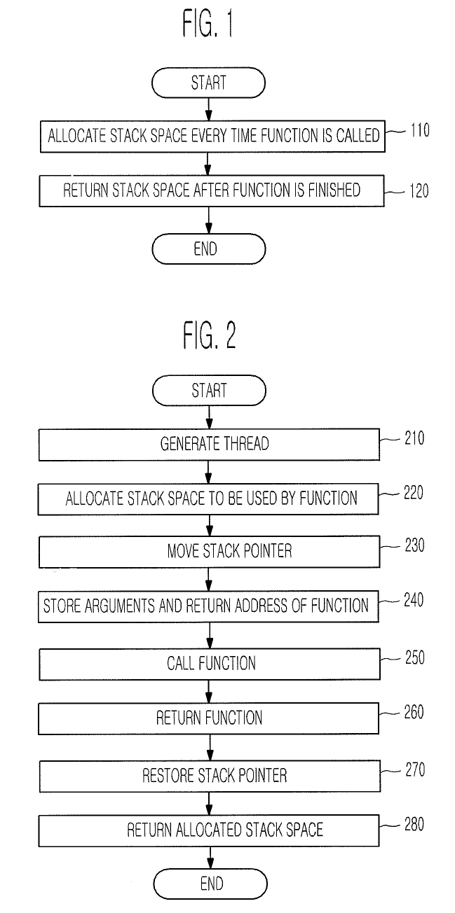

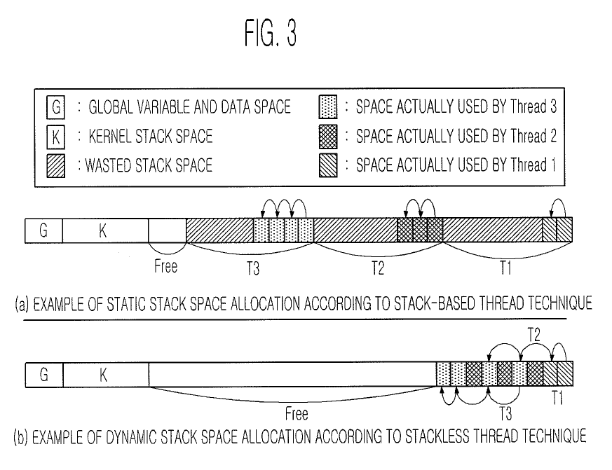

The method of allocating stack space according to an exemplary embodiment of the present invention will be described in more detail below with reference to FIG. 2.

Referring to FIG. 2, first, a thread to be executed in a multi-threaded sensor operating system environment is generated (step 210). As mentioned above, since an operating system operating at a sensor node needs to execute a plurality of threads for processing several operations in real time, such as sensing, communication, transition, etc., at least one thread may be generated.

When a function is called while the generated thread is performing an operation, stack space to be used by the function is allocated (step 220). The method of estimating the size of stack space has been already described with reference to FIG. 1. In other words, the allocated amount of stack space is estimated on the basis of the size of a local variable to be used by a function to be called and the number of function arguments. Furthermore, the assembly codes corresponding to the function are analyzed so that a stack space size can be more accurately estimated. Then, a stack pointer is moved to point at the allocated stack space (step 230). Before moving the stack pointer, a current stack pointer is stored for later restoration.

Subsequently, the arguments and a return address of the function are stored in the stack (step 240).

Afterwards, when a function is called and executed (step 250), and operations of the function are finished, the function is returned (step 260).

Finally, the stack pointer is restored (step 270), and the stack space allocated in step 220 is returned (step 280).

A method of statically allocating a stack according to conventional art and the method of dynamically allocating a stack according to an exemplary embodiment of the present invention are compared according to functions in Table 1 below.

TABLE 1

| | Conventional art | Present invention |
|---|---|---|
| Point in time for | When a thread is | When a function is called |
| stack allocation | generated | |
| Stack allocation | Static | Dynamic |
| size | | |
| Function calling | The same as a general | Call a function after |
| method | function calling method | allocating a stack, and |
| | | return the stack when the |
| | | function is finished |
| Stack allocation | Required only once | May be required several |
| cost | | times |
| Stack space | Low | High |
| efficiency | | |
| Maximum | In inverse proportion to a | In inverse proportion to the |
| number of threads | stack size | degree of functional overlap |
| Stack overflow | Possible | Impossible |

According to the method of allocating a stack according to an exemplary embodiment of the present invention, stack space to be used by a thread is allocated every time a function is called, and thus a potential load may be put on execution time. However, efficiency of the entire stack space can be improved, and the maximum number of generated threads is in inverse proportion to the degree of functional overlap other than a stack size. Thus, the method of allocating a stack according to an exemplary embodiment of the present invention can generate more threads than the method of allocating a thread on the basis of a stack according to conventional art.

FIG. 3 illustrates examples of allocated stack space to compare a method of statically allocating a stack according to conventional art, with a method of dynamically allocating a stack according to an exemplary embodiment of the present invention. More specifically, FIG. 3 illustrates examples of memory use in an entire system according to conventional art and the present invention, when respective 3 threads Thread 1, Thread 2 and Thread 3 reiteratively call functions whose number ranges from the minimum 2 to the maximum 4.

FIG. 3(a) shows that stack space is wasted when stack spaces T1, T2 and T3 are allocated to the respective threads according to conventional art. On the other hand, FIG. 3(b) shows that when stack space is allocated every time a thread calls a function according to the present invention, remaining space is reserved as free space, and thus stack space is not wasted.

In other words, when the method of dynamically allocating a stack according to an exemplary embodiment of the present invention is employed, it is possible to minimize waste of stack space, thereby considerably reducing the used amount of an overall stack.

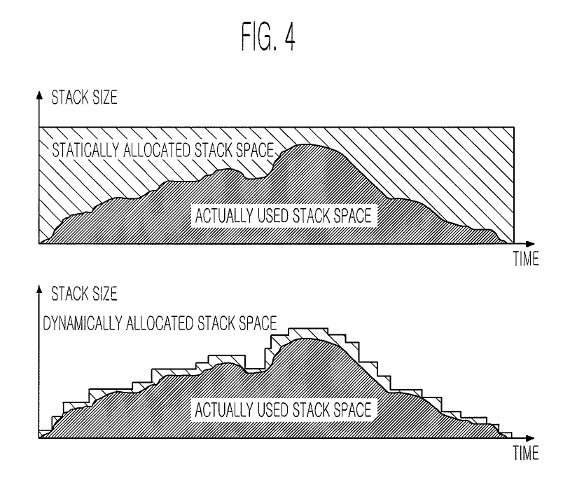

FIG. 4 is a graph showing amounts of allocated stack space to compare a method of allocating a stack in a multi-threaded sensor operating system environment, according to an exemplary embodiment of the present invention, with a conventional method of statically allocating a stack. It can be seen that the method of dynamically allocating a stack according to an exemplary embodiment of the present invention is very space-efficient.

As described above, the method according to an exemplary embodiment of the present invention dynamically allocates stack space required by threads. The allocation is performed every time a thread calls a function. And, when the function is finished, the allocated stack is returned, thereby allowing another thread to reuse the space. According to the inventive method of allocating a stack, a load for allocating and returning a memory space is generated, but an entire memory space can be efficiently used.

Therefore, it is possible to easily solve the problem of memory shortage caused when a multi-threaded task management technique is used in a space-limited wireless sensor operating system. In addition, since the problem of stack overflow can be prevented, the inventive method can be very usefully employed in a microcomputer system, such as a wireless sensor node not having a memory management unit (MMU).

The above-described present invention can be implemented in at least one computer-readable recording medium. For example, the computer-readable recording medium includes a floppy disk, a hard disk, a compact disk read-only memory (CD-ROM), a flash memory card, a programmable read-only memory (PROM), a random-access memory (RAM), a read-only memory (ROM), or a magnetic tape. In general, a computer-readable program can be written in a programming language, for example, Java, C, and C++.

According to the present invention as described above, the amount of stack space required by a thread is dynamically allocated. Therefore, it is possible to considerably reduce the amount of used memory space, in comparison with a conventional method of statically allocating a thread stack, and to prevent stack overflow. The present invention can be very usefully employed in a microcomputer system, such as a wireless sensor node not having an MMU.

While the invention has been shown and described with reference to certain exemplary embodiments thereof, it will be understood by those skilled in the art that various changes in form and details may be made therein without departing from the spirit and scope of the invention, as defined by the appended claims.

What is claimed is:

1. A method of dynamically allocating a stack in a multi-threaded sensor operating system environment, the method comprising the steps of:
whenever a function is called while a thread is performing an operation, dynamically allocating a stack space to be used by the function; and
when execution of the function is finished, returning the allocated stack space.

2. The method of claim 1, further comprising the step of:
estimating a size of the stack space to be allocated, on the basis of a size of a local variable to be used by the function and a number of function arguments.

3. The method of claim 1, further comprising the step of:
estimating a size of the stack space to be allocated by analyzing assembly codes corresponding to the function.

4. The method of claim 2, further comprising the step of:
storing information on the estimated size of the stack space,
wherein the stack space is allocated on the basis of the stored size information.

5. The method of claim 3, further comprising the step of:
storing information on the estimated size of the stack space,
wherein the stack space is allocated on the basis of the stored size information.

6. A method of dynamically allocating a stack in a multi-threaded sensor operating system environment, the method comprising the steps of:
when a function is called while a thread is performing an operation, allocating stack space to be used by the function;
moving a stack pointer to point at the allocated stack space;
storing arguments and a return address of the function in the stack space;
when execution of the function is finished, returning the function; and
restoring the stack pointer, and returning the allocated stack space.

7. The method of claim 6, further comprising the step of:
estimating a size of the stack space to be allocated, on the basis of a size of a local variable to be used by the function and a number of the function arguments.

8. The method of claim 6, further comprising the step of:
estimating a size of the stack space to be allocated by analyzing assembly codes corresponding to the function.

9. The method of claim 7, further comprising the step of:
storing information on the estimated size of the stack space,
wherein the stack space is allocated on the basis of the stored size information.

10. The method of claim 8, further comprising the step of:
storing information on the estimated size of the stack space,
wherein the stack space is allocated on the basis of the stored size information.

11. A computer-readable recording medium storing a computer program for carrying out a method of dynamically allocating a stack, the method comprising the steps of:
whenever a function is called while a thread is performing an operation, dynamically allocating a stack space to be used by the function; and
when execution of the function is finished, returning the allocated stack space.

12. The computer-readable recording medium of claim 11, wherein the method further comprises a step of estimating a size of the stack space to be allocated, on the basis of a size of a local variable to be used by the function and a number of function arguments.

13. The computer-readable recording medium of claim 11, wherein the method further comprises a step of estimating a size of the stack space to be allocated by analyzing assembly codes corresponding to the function.

14. The computer-readable recording medium of claim 12, wherein the method further comprises a step of storing information on the estimated size of the stack space, the stack space being allocated on the basis of the stored size information.

15. The computer-readable recording medium of claim 13, wherein the method further comprises a step of storing information on the estimated size of the stack space, the stack space being allocated on the basis of the stored size information.

16. The computer-readable recording medium of claim 11, wherein the computer program is executed at a sensor node having a limited-capacity memory.
